(19) United States
(12) Patent Application Publication
(10) Pub. No.: US 2025/0155839 A1
(43) Pub. Date: May 15, 2025

(54) FIXING DEVICE AND IMAGE FORMING APPARATUS

(71) Applicant: CANON KABUSHIKI KAISHA, Tokyo (JP)

(72) Inventors: TOMOAKI TANTO, Chiba (JP); TAKAHIRO KAYAMA, Ibaraki (JP)

(21) Appl. No.: 18/901,409

(22) Filed: Sep. 30, 2024

(30) Foreign Application Priority Data
Nov. 13, 2023 (JP) 2023-192730

(51) Int. Cl. G03G 15/20

(52) U.S. Cl. CPC G03G 15/2028; G03G 15/2064

(57) ABSTRACT

A fixing device is disclosed that has: a heating rotating member; an opposing member configured to be rotatable and to form a nip portion together with the rotating member, the nip portion being configured to nip and convey a recording material bearing a toner image with the recording material bearing the toner image pressed and heated; and a separating member configured to separate the recording material that has passed the nip portion from the rotating member, wherein the separating member includes: a tip portion configured to separate the recording material from the rotating member by the recording material that has passed through the nip portion abutting on the tip portion; and a guiding portion provided downstream of the tip portion in a conveying direction of the recording material and configured to guide the recording material separated by the tip portion, and wherein at least a surface of the tip portion is formed with fluororesin and the tip portion is secured to the guiding portion in a detachably attachable manner.

### BACKGROUND OF THE INVENTION

### Field of the Invention

This invention relates to a fixing device that fixes a toner image onto a recording material, and to an image forming apparatus of an electrophotographic system that can form an image on a recording material with the fixing device such as a copying machine, a printer, and a facsimile.

### Description of the Related Art

A conventional fixing device that fixes an unfixed toner image on a recording medium by heating and melting generally adopts a roller fixing method in which a pressure roller is pressed on a fixing roller that has a heater inside to form a nip portion where the fixing is performed. Recently, a fixing device with a film heating system is put into a practical use in view of the quick-start property and the energy-saving property.

A fixing device with the film heating system, for example, forms a fixing nip portion between a ceramic heater as a heating member and a pressure roller as a pressing member via a fixing film as a heat transferring member. A recording material on which a unfixed toner image is formed and born is introduced into the fixing nip portion where the recording material is nipped and conveyed together with the fixing film. During this process, with heat generated by the ceramic heater is provided to the recording material via the fixing film and with the pressuring force of the fixing nip portion, an unfixed toner image is fixed onto the recording material.

In this case, due to the stickiness of the melted toner, the recording material tends to stick to the surface of the fixing film, so that the recording material that has passed trough the fixing nip portion may be wound onto the fixing film. This is one of the problems to be solved for a fixing device with film heating system.

One of the techniques to solve this problem is to separate the recording material from the fixing film by a separating member disposed in the proximity to the fixing film in a recording material conveying region of the fixing film in the longitudinal direction perpendicular to the conveying direction of the recording material, and to convey the separated recording material in a predetermined direction. Further, a separating guide for separating a recording material from the fixing member which inserts a tip portion of the separating member between the recording material and the fixing film has been put in a practical use.

A separating performance becomes higher as such a separating guide is placed closer to the fixing film, whereas when the separating guide brings into contact with the fixing film, the fixing film is damaged to cause an image defect. Therefore, the separating guide should be placed such that the tip portion of the separating guide, which is located closest to the fixing film, is placed away at a desired distance, taking the dimensional tolerance between the fixing film and the separating guide into consideration. Japanese Patent Application Laid-open No. 2018-054729 discloses a fixing device whose separating performance of the recording material from the fixing film is improved by placing the separating guide closer the fixing film by reducing the warp the separating guide.

Further, when separating the recording material from the fixing film, the recording material abuts on the tip portion of the separating guide used in the fixing device. Therefore, when the fixing device is used for a long period of time, the tip portion of the separating guide, which touches the fixing film, may be progressively abraded by the friction between the tip portion and the recording material. Furthermore, foreign substances such as toner and paper powder may deposit on the tip portion of the separating guide.

In recent years, in order to reduce the burden on the environment, it is required to deal with the realization of the resource-recycling society by selecting the parts or the units that can be reused from the used products to increase the rate of the parts that can be reused or recycled. The fixing device with a film heating system is exchanged several times during the warrant usage period of the image forming apparatus and the parts of the fixing device are collected for reuse or recycle and it is determined whether respective parts can be reused or not.

### SUMMARY OF THE INVENTION

A representative configuration of the present invention is a fixing device configured to fix a toner image on a recording material, comprising:
a heating rotating member;
an opposing member configured to be rotatable and to form a nip portion together with the rotating member, the nip portion being configured to nip and convey the recording material bearing the toner image with the recording material being pressed; and
a separating member configured to separate the recording material that has passed the nip portion from the rotating member,
wherein the separating member includes:
   a tip portion configured to separate the recording material from the rotating member by the recording material that has passed through the nip portion abutting on the tip portion; and
   a guiding portion provided downstream of the tip portion in a conveying direction of the recording material and configured to guide in the conveying direction the recording material separated by the tip portion, and
wherein at least a surface of the tip portion is formed with fluororesin and the tip portion is secured to the guiding portion in a detachably attachable manner.

Further features of the present invention will become apparent from the following description of exemplary embodiments with reference to the attached drawings.

### BRIEF DESCRIPTION OF THE DRAWINGS

FIG. 1 is a schematic diagram showing an image forming apparatus according to an embodiment of the present invention.

FIGS. 2A and 2B are schematic diagrams each showing a cross-section of a fixing device according to the embodiment of the present invention.

FIG. 3 is a diagram showing a perspective view of a separating guide of the fixing device according to the embodiment of the present invention.

FIG. 4 is a diagram showing an exploded perspective view of the separating guide of the fixing device according to the embodiment of the present invention.

FIGS. 5A and 5B are flowchart of the procedures of reuse of the separating guide of the fixing device according to the embodiment of the present invention.

FIG. 6 is a flowchart of the procedures of reuse of the separating guide of the fixing device according to a conventional fixing device for the comparison with the fixing device according to the embodiment of the present invention.

### DESCRIPTION OF THE EMBODIMENTS

Hereinafter, with reference to the drawings, a preferred embodiment of the present invention will be described in detail.

### <Configuration of Image Forming Apparatus>

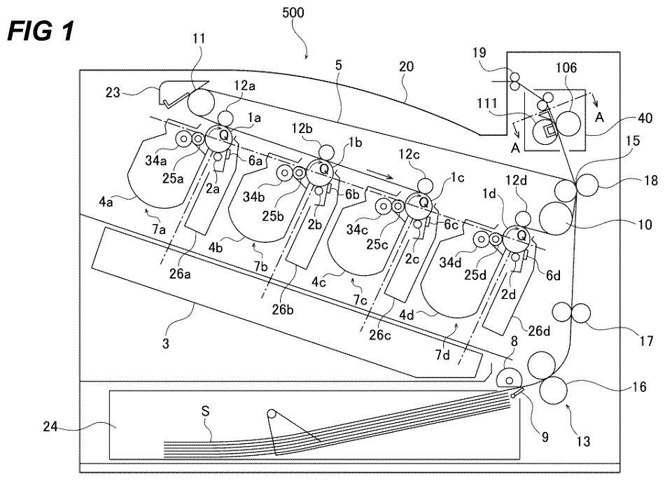

The configuration of the image forming apparatus 500 according to an embodiment of the present invention will be described in detail referring to FIG. 1.

The image forming apparatus 500 includes the charging rollers 2a, 2b, 2c and 2d, the scanner unit 3, the intermediate transfer film 5, the cleaning members 6a, 6b, 6c and 6d, the cartridges 7a, 7b, 7c and 7d, the driving roller 10, the tension roller 11, the primary transfer rollers 12a, 12b, 12c and 12d, the feeding device 13, the secondary transfer portion 15, the registration roller pair 17, the discharge roller pair 19, the discharge tray 20, the transfer film cleaning device 23, and the fixing device 40.

The charging rollers 2a, 2b, 2c and 2d, the scanner unit 3, the intermediate transfer film 5, the cartridges 7a, 7b, 7c and 7d, the primary transfer rollers 12a, 12b, 12c and 12d, and the secondary transfer portion 15 constitute an image forming portion.

The charging rollers 2a, 2b, 2c and 2d uniformly charge the surfaces of the photosensitive drums 1a, 1b, 1c and 1d, respectively.

The scanner unit 3 is disposed below the cartridges 7a, 7b, 7c and 7d. The scanner unit 3 irradiates the surfaces of the photosensitive drums 1a, 1b, 1c and 1d respectively charged by the charging rollers 2a, 2b, 2c and 2d with laser beams via a unit opening portion (not shown) to expose the photosensitive drums so that an electrostatic latent image is formed on the surfaces of the photosensitive drums 1a, 1b, 1c and 1d.

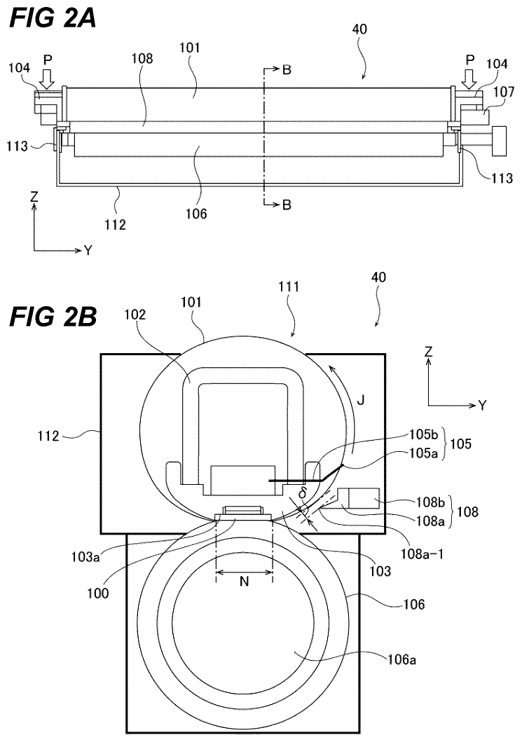

The intermediate transfer film 5 is stretched by the driving roller 10 and the tension roller 11 and is driven to rotate in the direction of the arrow R in FIG. 2. The toner images of the four colors respectively formed on the photosensitive drums 1a, 1b, 1c and 1d are primarily transferred and sequentially superimposed by the primary transfer rollers 12a, 12b, 12c and 12d. The intermediate transfer film 5 conveys the toner images of the four colors transferred and superimposed.

The cleaning members 6a, 6b, 6c and 6d remove remaining toner left on the photosensitive drums 1a, 1b, 1c and 1d after the toner images formed on the photosensitive drums 1a, 1b, 1c and 1d have been transferred onto the intermediate transfer film 5. The remaining toner removed by the cleaning members 6a, 6b, 6c and 6d is collected into a removed toner chamber in the photosensitive drum units 26a, 26b, 26c and 26d.

As shown in FIG. 1, the four cartridges 7a, 7b, 7c and 7d are parallelly provided in an oblique direction. The cartridges 7a, 7b, 7c and 7d are respectively provided with the photosensitive drum units 26a, 26b, 26c and 26d and the developing units 4a, 4b, 4c and 4d.

The photosensitive drum units 26a, 26b, 26c and 26d respectively have the photosensitive drums 1a, 1b, 1c and 1d.

The photosensitive drums 1a, 1b, 1c and 1d are respectively driven to rotate in the clockwise direction (the direction indicated by Q) in FIG. 1 by a driving member (not shown). The cleaning members 6a, 6b, 6c and 6d, the charging rollers 2a, 2b, 2c and 2d, the developing units 4a, 4b, 4c and 4d are disposed around the photosensitive drums 1a, 1b, 1c and 1d in this order, respectively.

The developing units 4a, 4b, 4c and 4d respectively supply the electrostatic latent images formed on the surfaces of the photosensitive drums 1a, 1b, 1c and 1d with toner to develop the electrostatic latent images into the toner images. The developing units 4a, 4b, 4c and 4d are respectively provided with the developing rollers 25a, 25b, 25c and 25d, and the supplying rollers 34a, 34b, 34c and 34d.

The developing rollers 25a, 25b, 25c and 25d bring into contact with the photosensitive drums 1a, 1b, 1c and 1d and supply the surfaces of the photosensitive drums 1a, 1b, 1c and 1d with toner supplied by the supplying rollers 34a, 34b, 34c and 34d.

The supplying rollers 34a, 34b, 34c and 34d bring into contact with the developing rollers 25a, 25b, 25c and 25d and supply the developing rollers 25a, 25b, 25c and 25d with toner on the developing rollers 25a, 25b, 25c and 25d.

The driving roller 10 is provided inside the intermediate transfer film 5 and drives to rotate the intermediate transfer film 5 by a driving force being transmitted from a driving source (not shown).

The tension roller 11 is provided inside the intermediate transfer film 5 and provides the intermediate transfer film 5 with a tension.

The primary transfer rollers 12a, 12b, 12c and 12d are disposed inside the intermediate transfer film 5 respectively being opposed to the photosensitive drums 1a, 1b, 1c and 1d via the intermediate transfer film 5. Transfer biases are applied to the primary transfer rollers 12a, 12b, 12c and 12d by bias applying means (not shown). For example, when negatively charged toner is used, positive biases are applied to the primary transfer rollers 12a, 12b, 12c and 12d. When the transfer biases are applied, the primary transfer rollers 12a, 12b, 12c and 12d primarily transfer the toner images formed on the surfaces of the photosensitive drums 1a, 1b, 1c and 1d onto the intermediate transfer film 5.

The feeding device 13 includes the feeding roller 8, the separating pad 9, the conveying roller pair 16 and the sheet cassette 24. The feeing device 13 feeds the recording materials S to the registration roller pair 17.

The feeding roller 8 presses the uppermost recording material S out of the recording materials S accommodated in the sheet cassette 24 so that the recording materials S accommodated in the sheet cassette 24 are fed to the conveying roller pair 16 by the rotation of the feeding roller 8.

The separating pad 9 separates the recording materials S fed by the feeding roller 8 one by one.

The conveying roller pair 16 conveys the recording material S fed by the feeding roller 8 to the registration roller pair 17.

The sheet cassette 24 is configured to be detachably attachable to the image forming apparatus 500, and to accommodate multiple recording materials S.

The secondary transfer portion 15 is provided with the secondary transfer roller 18. In the secondary transfer portion 15, a positive bias is applied to the secondary transfer roller 18 so that the toner imagers primarily transferred on the intermediate transfer film 5 are secondarily transferred onto the conveyed recording material S conveyed by the registration roller pair 17. Further, the recording material S on which the toner image has been secondarily transferred is conveyed by the secondary transfer portion 15 to the fixing device 40.

Meanwhile, the registration roller pair 17 conveys the recording material S conveyed by the conveying roller pair 16 of the feeding device 13 to the secondary transfer portion 15 in synchronism with the image forming operation.

The recording material S conveyed by the fixing device 40 is discharged onto the discharge tray 20 by the discharge roller pair 19.

The recording materials S are accommodated on the discharge tray 20 after discharged by the discharge roller pair 19.

The toner left on the intermediate transfer film 5 after the secondary transfer to the recording material S with the secondary transfer portion 15 is removed by the transfer film cleaning device 23.

The fixing device 40 adopts the film heating system and the pressure roller driving system. The fixing device 40 fixes the toner image on the recording material S by applying heat and pressure to the toner image secondarily transferred on the recording material S by the secondary transfer portion 15. The recording material S on which the toner image is fixed is conveyed to the discharge roller pair 19 by the fixing device 40.

### <Configuration of Fixing Device>

Next, the configuration of the fixing device 40 according to the present embodiment will be described referring to FIGS. 2A and 2B.

FIG. 2A is a diagram showing the A-A cross-sectional view of FIG. 1. FIG. 2B is a diagram showing the B-B cross-sectional of FIG. 2A.

The fixing device 40 includes the pressure roller 106, the separating guide 108, the film unit 111, the fixing frame 112 and the bearing members 113.

The widthwise direction of the film unit 111 is defined as the direction X, the longitudinal direction of the film unit 111 is defined as the direction Y, and the pressing direction of the film unit 111 is defined the direction Z.

The pressure roller 106 as an opposed member includes the core metal 106a, and a heat-resistant elastic layer co-axially and integrally provided on the core metal 106a. The elastic layer is molded and covers the core metal 106a in a roller-shape by the material such as silicone rubber, fluoro rubber, fluoro resin and the like, which have heat resist properties. Further, a toner releasing layer is provided on the surface layer around the elastic layer of the pressure roller 106. The toner releasing layer is formed by the material such as fluoro resin, silicone resin, fluoro silicone rubber, fluoro rubber, silicone rubber, PFA, PTFE, FEP and the like, which show good toner releasing properties and heat resist properties.

The pressure roller 106 forms the nip portion N between the fixing film 101 and the pressure roller 106 by pressing the pressing member 103 of the film unit 111 via the fixing film of the film unit 111. The pressure roller 106 is driven to rotate by a fixing motor (not shown) provided in the image forming apparatus 500.

The separating guide 108 as a separating member is attached to the fixing frame 112. The separating guide 108 separates the recording material S that has adhered to the fixing film 101 from the fixing film 101 after the recording material S has passed through the nip portion N. The detailed configuration of the separating guide 108 will be described later.

The film unit 111 includes the heater 100, the fixing film 101, the stay 102, the pressing member 103, the fixing flange 104, the thermistor 105 and the connector 107.

The heater 100 as a heating member is fitted into the fitting groove 103a of the pressing member 103. The heater 100 has a low heat capacity so that the temperature of the heater 100 increases with rapid temperature rising characteristics when electric power is supplied from an electrical power source (not shown) of the image forming apparatus 500 to the heater 100. The heater 100 has a long, narrow, and thin plate-shaped ceramic board (not shown) and an energization heat generating resistor layer (not shown) provided on the ceramic board. The electrical power is provided to the energization heat generating resistor so that the heater heats the fixing film 101.

The fixing film 101 as a heating rotating member is a cylindrical, heat-resistant and endless heating member for transmitting heat to the recording material S and is loosely and outwardly fitted to the pressing member 103. In order to improve the quick start property by decreasing the heat capacity, the fixing film 101 has a film thickness smaller than 100 μm, preferably equal to or greater than 20 μm and equal to or smaller than 50 μm. The fixing film 101 can be made from a single layer of PTFE, PFA, and FEP or composite layers including a basic layer of polyimide, polyamide imide, PEEK, PES, PPS or the like and a coating of PTFE, PFA, FEP or the like on the outer peripheral surface of the basic layer. Further, the fixing film 101 may not be made from the above materials and can be made from metal.

The fixing film 101 rotates in the direction indicated by arrow J in FIG. 2B by following the rotation of the pressure roller 106.

The stay 102 is disposed at the inner surface side of the fixing film 101. The stay 102 is pressed onto the back surface of the pressing member 103, which is opposite to the surface opposed to the fixing film 101 in order to increase the strength of the pressing member 103 in the longitudinal direction. The stay 102 is provided to straighten the pressing member 103.

The pressing member 103 is of a substantially semicircular shape in a cross-section with its longitudinal direction, which is the direction crossing the conveying direction of the recording material S (hereinafter referred to as just the “longitudinal direction”). The pressing member 103 has heat-resistant and adiabatic properties. Phenolic resin, polyimide resin, polyamide resin, polyamide imide resin, PEEK resin, PES resin, PPS resin, PFA resin, PTFE resin, LCP resin, and the like, which are comparatively flexible and show good insulating and heat-resistant properties are used for the material of the pressing member 103.

The fitting groove 103a is provided on the lower surface of the pressing member 103, which is opposed to the fixing film 101. The fitting groove 103a is recessed along the longitudinal direction. The pressing member 103 forms the nip portion N on the fixing film 101 and the pressure roller 106 by pressing the pressure roller 106 via the fixing film 101 as a backup member for the fixing film 101. The pressing member 103 has functions of pressing the recording material S with the pressure roller 106 at the nip portion N, stabilizing the conveyance of the fixing film 101 during rotation, and holding the heater 100 as a holding member.

The fixing flange 104 is fitted to each end of the assembly body of the pressing member 103 and the stay 102 in the longitudinal direction. The fixing flange 104 guides the rotation of the fixing film 101 and prevents the fixing film 101 from being disengaged in the longitudinal direction by restricting the movement of the fixing film 101 in the longitudinal direction. The fixing flanges 104 is urged in the direction indicated by arrow P shown in FIG. 2A from a pressure plate (not shown) attached to the fixing frame 112.

The thermistor 105 is fixed to and held by the pressing member 103 and is in contact with the inner circumferential surface of the fixing film 101. The thermistor 105 outputs an electrical signal corresponding to a temperature of the inner circumferential surface of the fixing film 101 to a control circuit portion (not shown). Thermistor 105 includes the temperature detecting element portion 105a and the plate spring portion 105b.

The temperature detecting element portion 105a is in contact with the inner surface of the fixing film 101 to detect a temperature of the inner surface of the fixing film 101.

The plate spring portion 105b has flexibility and urges the temperature detecting element portion 105a to the inner circumferential surface of the fixing film 101 at a predetermined contact pressure. The plate spring portion 105b is made of stainless steel and forms an electrically conductive path for the temperature detecting element portion 105a.

The connector 107 supplies electrical power from an electrical power source portion (not shown) of the image forming apparatus 500 to the heater 100.

A pressure plate (not shown) for pressing the film unit 111 and the pressure roller 106 on each other via the fixing flange 104 is rotatably attached to the fixing frame 112.

The bearing members 113 are formed from heat-resistant resin such as PEEK, PPS and liquid crystal polymer. The bearing members 113 are provided on the fixing frame 112. The bearing members 113 are provided on both end portions of the core metal 106a of the pressure roller 106 in the longitudinal direction and rotatably support the core metal 106a.

The fixing device 40 with the above configuration thermally fixes a toner image on the recording material S by applying heat and pressure to the toner image secondarily transferred on the recording material S during the process of nipping and conveying the recording material S at the nip portion N by the fixing film 101 and the pressure roller 106. In this case, the recording material S adheres to the surface of the fixing film 101 due to the melting of the toner image, and thereafter the recording material S is separated from the surface of the fixing film 101 by the separating guide 108.

### <Configuration of Separating Guide>

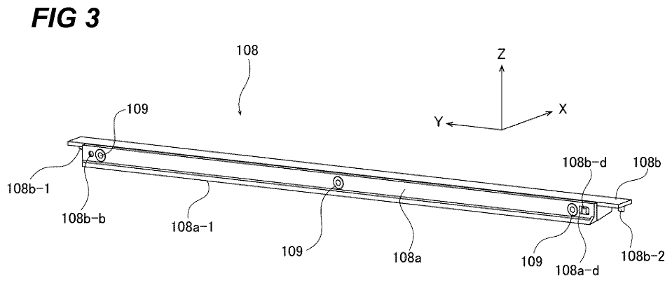

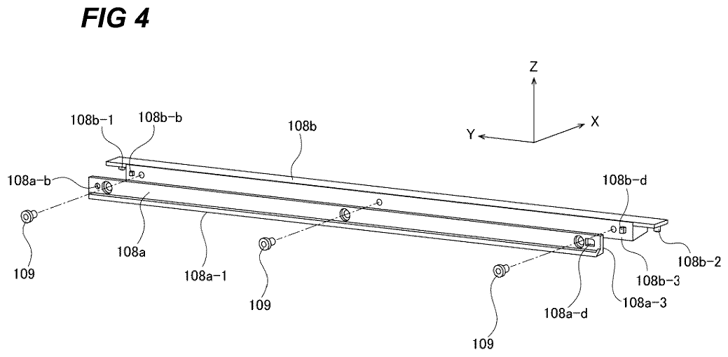

Next, the configuration of the separating guide 108 of the fixing device 40 according to the embodiment of the present invention will be described referring to FIGS. 2 to 4.

The separating guide 108 is provided with the tip portion 108a and the guiding portion 108b.

The tip portion 108a is formed by resin material and is a separate member from the guiding portion 108b. The tip portion 108a is at least longer than the length of the recording material S in the width direction perpendicular to the conveying direction of the recording material S. The tip portion 108a is secured to the guiding portion 108b in a detachably attachable manner. The tip portion 108a is formed by fluoro-resin such as PFA, PTFE and ETFE so that the toner and dirt are hard to be attached to the tip portion 108a. The tip portion is formed by the same material as that of the guiding portion 108b. The tip portion 108a is provided in the vicinity of the fixing film 101 with the gap 8 to the fixing film 101 (See FIG. 2B). The gap 8 is set by a predetermined standard and is exemplified as 1.0 mm in this embodiment. The tip portion 108a is exchanged with a new one more frequently than the guiding portion 108b. The configuration of the tip portion 108a is not limited to the one whose entirety is formed by fluoro-resin and might be the one whose surface is only coated with fluoro-resin. When the tip portion 108a is coated with fluoro-resin, the material of the tip portion 108a is heat-resistant resin such as PPS resin, LCP resin, or resin consisting of PBT resin and ABS resin.

The tip portion 108a is provided with the abutting portion 108a-1, the contact surface 108a-3, the positioning hole 108a-b, and the positioning hole 108a-d.

When the tip of the recording material S in the conveying direction conveyed with the rotation of the fixing film 101 abuts on the contact surface 108a-1, the contact surface 108a-1 separates the recording material S from the fixing film 101.

The contact surface 108b-3 of the guiding portion 108b is in contact with the contact surface 108a-3.

The positioning hole 108a-b as a first engaging portion is a round hole and engages with the positioning portion 108b-b of the guiding portion 108b.

The positioning hole 108a-d as a first engaging portion is an elongated round hole and engages with the positioning portion 108b-d of the guiding portion 108b.

The guiding portion 108b is formed with resin material. The guiding portion 108b is provided downstream of the tip portion 108a in the conveying direction. The guiding portion 108b guides the recording material S separated from the fixing film 101 by the tip portion 108a to downstream of the nip portion N in the conveying direction. The material of the tip portion 108b is heat-resistant resin such as PPS resin, LCP resin, or resin consisting of PBT resin and ABS resin. In view of heat expansion, it is desirable that the material of the tip portion 108a is the same as that of the guiding portion 108b.

The tip portion 108b is provided with the positioning portion 108b-1, the positioning portion 108b-2, the contact surface 108b-3, the positioning portion 108b-b, and the positioning portion 108b-d.

The positioning portion 108b-1 is provided at one end portion on the separating guide 108 in the longitudinal direction. By being attached to the fixing frame 112, the positioning portion 108b-1 positions the separating guide 108.

The positioning portion 108b-2 is provided at the other end portion on the separating guide 108 in the longitudinal direction. By being attached to the fixing frame 112, the positioning portion 108b-2 positions the separating guide 108.

The contact surface 108a-3 of the guiding portion 108a is in contact with the contact surface 108b-3.

The positioning hole 108b-b as a second engaging portion engages with the positioning hole 108a-b.

The positioning hole 108b-d as a second engaging portion engages with the positioning hole 108a-d.

The separating guide 108, which has been described above, is configured such that the tip portion 108a and the guiding portion 108b are integrally secured by the screw or screws 109 as a securing member at a single location or multiple locations. Specifically, the separating guide 108 is configured such that the tip portion 108a and the guiding portion 108b are integrally fastened by the screws 109 at three locations including both end portions and a central portion in the longitudinal direction with even gaps.

By the positioning hole 108a-b of the tip portion 108a engaging with the positioning portion 108b-b of the guiding portion 108b, the tip portion 108a is positioned with respect to the guiding portion 108b in the direction Y and the direction Z. By the positioning hole 108a-d of the tip portion 108a engaging with the positioning portion 108b-d of the guiding portion 108b, the tip portion 108a is positioned with respect to the guiding portion 108b in the direction Z. Further, the contact surface 108b-3 of the guiding portion 108b being in contact with the contact surface 108a-3 of the tip portion 108a, the tip portion 108a is positioned with respect to the guiding portion 108b in the direction X.

### <Operation of Image Forming Apparatus>

The operation of the image forming apparatus 500 according to the embodiment of the present invention will be described referring to FIG. 1.

When a main power (not shown) is turned on, the image forming apparatus 500 starts the image forming operation and the conveying operation.

In the image forming operation, the surfaces of the photosensitive drums 1a, 1b, 1c and 1d are uniformly charged by the primary transfer rollers 12a, 12b, 12c and 12d, respectively.

When the surfaces of the photosensitive drums 1a, 1b, 1c and 1d which are uniformly charged are eradiated with laser beams by the scanner unit 3, electrostatic latent images are respectively formed on the surfaces of the photosensitive drums 1a, 1b, 1c and 1d.

Next, toner images are formed on the surfaces of the photosensitive drums 1a, 1b, 1c and 1d on which the electrostatic latent images are formed by supplying toner by the developing units 4a, 4b, 4c and 4d, respectively.

Next, the toner images formed on the surfaces of the photosensitive drums 1a, 1b, 1c and 1d are primarily transferred on the intermediate transfer film 5 by the intermediate transfer rollers 12a, 12b, 12c and 12d, respectively. When a negatively charged toner is used, for example, the toner images are primarily transferred on the same position on the intermediate transfer film 5 in a sequential manner by positive biases being applied to the primary transfer rollers 12a, 12b, 12c and 12d. The superimposed four-color toner image is conveyed to the secondary transfer portion 15 by the intermediate transfer film 5.

In the conveying operation which is synchronism with the above described image forming operation, the recording material S fed to the registration roller pair 17 is conveyed to the secondary transfer portion 15 by the registration roller pair 17. In this case, the feeding device 13 feeds the recording material S by the friction piece separation method, in which recording materials S are separated one by one by the separating pad 9, with the rotation of the feeding roller 8 which presses the recording material S which is located at the most upper position out of the recording materials S accommodated in the feeding cassette 24.

When a positive bias is applied to the secondary transfer roller 18, a four-color toner image on the intermediate transfer film 5 is secondarily transferred on the recording material S conveyed to the secondary transfer portion 15 by the registration roller pair 17. Then, the recording material S on which the four-color toner image has been secondarily transferred is conveyed to the fixing device 40 by the secondary transfer portion 15.

Next, by applying heat and pressure with the fixing device 40 to the recording material S on which the toner image has been secondarily transferred, the toner image is fixed on the recording material S.

Next, the recording material S on which the toner image has been fixed is discharged onto the discharge tray 20 by the discharge roller pair 19.

The toner remaining on the intermediate transfer film 5 after the secondary transfer of the toner image onto the recording material S at the secondary transfer portion 15 is removed by the transfer film cleaning device 23. The toner removed by the transfer film cleaning device 23 is collected into a waste toner collecting container (not shown) after passing through a waste toner conveying path (not shown).

When recording materials S should be replenished to the feeding cassette 24, a user draws the feeding cassette 24 to disengage the feeding cassette 24 from the apparatus main body of the image forming apparatus 500. Then, the user sets new recording materials S in the disengaged feeding cassette 24 and inserts the feeding cassette 24 in which the new recording materials S are set into the apparatus main body of the image forming apparatus 500. This completes the replenishment of recording materials S in the feeding device 13.

### <Procedures of Reuse of Separating Guide>

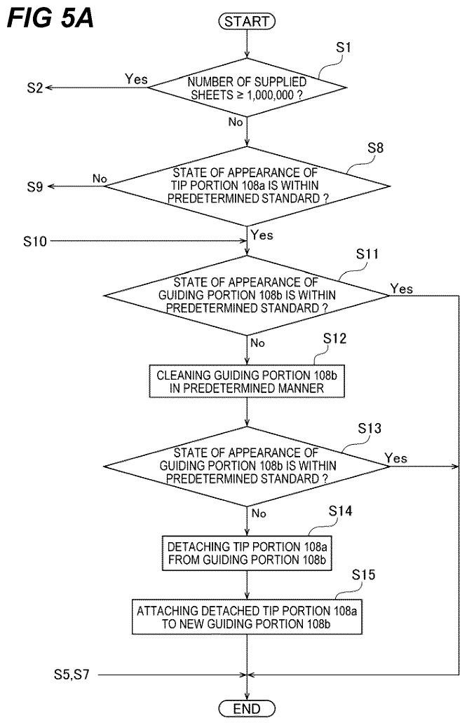

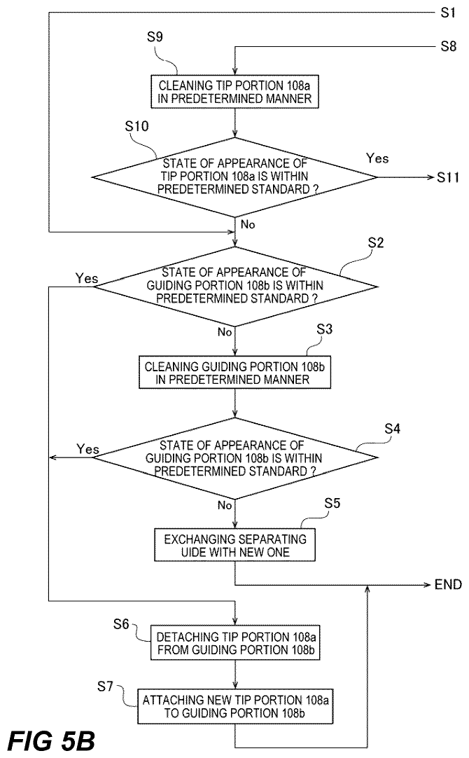

Next, the procedures of reusing the separating guide 108 of the fixing device 40 according to the embodiment of the present invention will be described in detail referring to FIGS. 5A and 5B.

First, a user confirms the number of supplied sheets in the history of the supplied sheets which is associated with the fixing device 40 that has been used and collected and judges whether the number of supplied sheets is equal to or greater than 1,000,000 (step S1).

When the number of supplied sheets is equal to or greater than 1,000,000 (step S1: Yes), a user judges whether the state of the appearance of the guiding portion 108b is within the predetermined standard (step S2). When the number of supplied sheets is equal to or greater than 1,000,000, the tip portion 108a of the separating guide 108 may have been worn due to the friction with the recording materials S so that the gap 8 between the tip portion 108a and the fixing film 101 becomes without the predetermined standard. Therefore, in this case, at least the collected tip portion 108a is required to be exchanged with a new one. The predetermined standard in this embodiment is exemplified as 1.0 mm+0.1 mm.

When the state of the appearance of the guiding portion 108b is without the predetermined standard (step S2: No), the user cleans the guiding portion 108b in a predetermined manner (step S3).

Next, the user confirms again the state of the appearance of the guiding portion 108b and judges whether the state of the appearance of the guiding portion 108b is within the predetermined standard (step S4).

When the state of the appearance of the guiding portion 108b is without the predetermined standard (step S4: No), the guiding portion 108b cannot be used again, so that the entirety of the separating guide 108 cannot be used again. In this case, the user exchanges the separating guide 108 with a new one (step S5). Thereafter, the user completes the procedures of reuse.

The procedures in which the above steps S1 to S5 are performed in this order are for the case where neither of the tip portion 108a and the guiding portion 108b of the separating guide 108 collected from the fixing device 40 is reusable and the separating guide 108 has to be exchanged with a new one.

When the state of the appearance of the guiding portion 108b in the step S2 is within the predetermined standard (step S2: Yes), the user exchanges only the reusable tip portion 108a since the guiding portion 108b is reusable as it is. In this case, the user releases the fastening of the tip portion 108a and the guiding portion 108b by the screws 109 and detaches the tip portion 108a from the guiding portion 108b (step S6).

Next, the user fastens the new tip portion 108a with the guiding portion 108b in use with the screws 109 so that the new tip portion 108a is attached to the guiding portion 108b in use (step S7), and thereafter completes the procedures of reuse. In this case, the positioning hole 108a-b of the tip portion 108a is engaged with the positioning portion 108b-b of the guiding portion 108b. Further, the positioning hole 108a-d of the tip portion 108a is engaged with the positioning portion 108b-d of the guiding portion 108b. In this manner, the tip portion 108a and the guiding portion 108b can be provisionally secured, so that the tip portion 108a and the guiding portion 108b can be easily fastened with the screws 109.

The procedures in which the above steps S1, S2, S6 and S7 are performed in this order are for the case where only the tip portion 108a of the separating guide 108 collected from the fixing device 40 is not reusable and the guiding portion 108b is reusable.

When the state of the appearance of the guiding portion 108b is within the predetermined standard in the step S4 (step S4: Yes), the user proceeds to the operation of the step S6.

The procedures in which the above steps S1 to S4, S6 and S7 are performed in this order are for the case where only the tip portion 108a of the separating guide 108 collected from the fixing device 40 is not reusable and the guiding portion 108b is reusable.

Meanwhile, when the number of supplied sheets is less than 1,000,000 in the step S1 (step S1: No), the user judges whether the state of the appearance of the tip portion 108a is within the predetermined standard (step S8).

When the state of the appearance of the tip portion 108a is without the predetermined standard (step S8: No), the user cleans the tip portion 108a in a predetermined manner (step S9).

Next, the user confirms again the state of the appearance of the tip portion 108a and judges whether the state of the appearance of the tip portion 108a is within the predetermined standard (step S10).

When the state of the appearance of the tip portion 108a is within the predetermined standard (step S10: Yes), the user judges whether the state of the appearance of the guiding portion 108b in within the predetermined standard (step S11).

When the state of the appearance of the guiding portion 108b is without the predetermined standard (step S11: No), the user cleans the guiding portion 108b in a predetermined manner (step S12).

Next, the user confirms again the state of the appearance of the guiding portion 108b and judges whether the state of the appearance of the guiding portion 108b is within the predetermined standard (step S13).

When the state of the appearance of the guiding portion 108b is without the predetermined standard (step S13: No), the tip portion 108a can be reused as it is. Therefore, the user exchanges only the guiding portion 108b that is not reusable. Then, the user releases the fastening of the tip portion 108a to the guiding portion 108b with the screws 109 and detaches the tip portion 108a from the guiding portion 108b (step S14).

Next, the user replaces the guiding portion 108b from which the tip portion 108a has been detached with a new one. Then, the user fastens the tip portion 108a in use with the new guiding portion 108b with the screws 109, so that the tip portion 108a in use is attached to the new guiding portion 108b (step S15). Thereafter, use completes the procedures for reuse.

The procedures in which the above steps S1, S8 to S15 are performed in this order are for the case where only the guiding portion 108a of the separating guide 108 collected from the fixing device 40 is not reusable and the tip portion 108a is reusable.

When the state of the appearance of the tip portion 108a is within the predetermined standard in the step S8 (step S8: Yes), the user proceeds to the step S11.

The procedures in which the above steps S1, S8 and S11 are performed in this order are for the case where at least the tip portion 108a is reusable.

Further, when the state of the appearance of the guiding portion 108b is within the predetermined standard in step S11 (step S11: Yes), the user completes the procedures of reuse without exchanging the tip portion 108a and the guiding portion 108b.

In the case of “Yes” in the step S11, both of the tip portion 108a and the guiding portion 108b are reusable.

Furthermore, when the state of the appearance of the guiding portion 108b is within the predetermined standard in step S13 (step S13: Yes), the user completes the procedures of reuse without exchanging the tip portion 108a and the guiding portion 108b.

In the case of “Yes” in the step S13, both of the tip portion 108a and the guiding portion 108b are reusable.

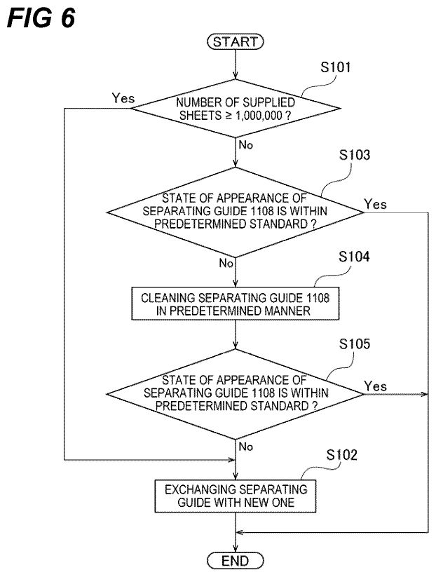

Next, as compared with the present embodiment, the procedures of reuse of the separating guide 1108 of a conventional fixing apparatus 140 will be described referring to FIG. 6.

In the conventional separating guide 1108, the tip portion 108a and the guiding portion 108b cannot be separated from each other, which is different from the separating guide 108 of the present embodiment. Namely, in the conventional separating guide 1108, the tip portion 108a and the guiding portion 108b are integrally formed as one with resin. The configuration of the conventional fixing device 140 excluding the separating guide 1108 is the same as that of the fixing device 40 and the description and illustration therefor have been omitted. Further, the illustration of the conventional separating guide 1108 has been omitted.

First, a user confirms the number of supplied sheets in the history of the supplied sheets which is associated with the fixing device 140 that has been used and collected and judges whether the number of supplied sheets is equal to or greater than 1,000,000 (step S101).

When the number of supplied sheets is equal to or greater than 1,000,000 (step S101: Yes), the user exchanges the separating guide 1108 with a new one since the separating guide 1108 is not reusable (step S102). Thereafter, the user completes the procedures for reuse.

The procedures in which the above steps S101 and S102 are performed in this order are for the case where the separating guide 1108 is exchanged with a new one since the separating guide 1108 collected from the fixing device 140 is not reusable.

Meanwhile, when the number of supplied sheets is less than 1,000,000 in the step S101 (step S101: No), the user judges whether the state of the appearance of the separating guide 1108 is within the predetermined standard (step S103).

When the state of the appearance of the separating guide 1108 is without the predetermined standard (step S103: No), the user cleans the separating guide 1108 in a predetermined manner (step S104).

Next, the user confirms again the state of the appearance of the separating guide 1108 and judges whether the state of the appearance of the separating guide 1108 is within the predetermined standard (step S105).

When the state of the appearance of the separating guide 1108 is without the predetermined standard (step S105: No), the separating guide 1108 cannot be used again, so that the user proceeds to the step S102.

The procedures in which the above steps S101, S103 to S105, and S102 are performed in this order are for the case where the separating guide 1108 is not reusable and is exchanged with a new one.

Further, when the state of the appearance of the separating guide 1108 is within the predetermined standard (step S103: Yes), the user completes the procedures of reuse without exchanging the separating guide 1108.

In the case of “Yes” in the step S103 when the above steps S101 and S103 are performed in this order, the separating guide 1108 collected from the fixing device 140 is reusable.

Further, when the state of the appearance of the separating guide 1108 is within the predetermined standard (step S105: Yes), the user completes the procedures of reuse without exchanging the separating guide 1108.

In the case of “Yes” in the step S105 when the above steps S101 and S103 to S105 are performed in this order, the separating guide 1108 collected from the fixing device 140 is reusable.

As described above, conventionally, even when only the tip portion of the separating guide 1108 is not reusable and the portion other than the tip portion is usable, it s necessary to exchange the entirety of the separating guide 1108 with a new one.

In contrast, in the present embodiment, only the tip portion, which is easy to wear by the sheet passing, is required to be exchanged, so that the guiding portion 108b can be reused. Further, when only the guiding portion 108b should be exchanged with a new one, the tip portion 108a can be reused. As a result, the reuse rate of used components can be improved, so that an image forming apparatus can be provided by which resources can be efficiently utilized and an environmental burden can be reduced.

In the present embodiment, the tip portion 108a is detachably attachable to the guiding portion 108b. With this configuration, the reuse rate can be improved without deteriorating the separation property of the recording material S from the fixing film 101, so that the resources can be efficiently utilized and the environmental burden can be reduced.

The present invention is not limited to the above embodiment and can be variously modified without departing from the gist of the present invention.

Specifically, although in the above described embodiment, the tip portion 108a and the guiding portion 108b are integrally fastened as one with the screws 109, the fastening means is not limited to this and the tip portion 108a and the guiding portion 108b are integrally fastened as one with other fastening means.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-192730, filed Nov. 13, 2023, which is hereby incorporated by reference herein in its entirety.

What is claimed is:

1. A fixing device configured to fix a toner image on a recording material, comprising:
a heating rotating member;
an opposing member configured to be rotatable and to form a nip portion together with the rotating member, the nip portion being configured to nip and convey the recording material bearing the toner image with the recording material being pressed; and
a separating member configured to separate the recording material that has passed the nip portion from the rotating member,
wherein the separating member includes:
a tip portion configured to separate the recording material from the rotating member by the recording material that has passed through the nip portion abutting on the tip portion; and
a guiding portion provided downstream of the tip portion in a conveying direction of the recording material and configured to guide in the conveying direction the recording material separated by the tip portion, and
wherein at least a surface of the tip portion is formed with fluororesin and the tip portion is secured to the guiding portion in a detachably attachable manner.

2. The fixing device according to claim 1,
wherein the tip portion is provided with a first engaging portion and the guiding portion is provided with a second engaging portion configured to engage with the first engaging portion.

3. The fixing device according to claim 1,
wherein the separating member is configured such that the tip portion and the guiding portion are integrally secured as one at one location or at multiple locations in a longitudinal direction by a securing member.

4. The fixing device according to claim 1,
wherein the tip portion is a plate-like member that is longer than at least a length of the recording material in a width direction.

5. The fixing device according to claim 1,
wherein the tip portion is formed with fluororesin.

6. The fixing device according to claim 1,
wherein the surface of the tip portion is coated with fluororesin.

7. The fixing device according to claim 1,
wherein the tip portion and the guiding portion are formed with a same material.

8. An image forming apparatus comprising:
the fixing device according to claim 1; and
an image forming portion configured to have the recording material bear the toner image and to convey the recording material bearing the toner image to the fixing device.
